(19) United States
(12) Patent Application Publication
(10) Pub. No.: US 2002/0101107 A1
(43) Pub. Date: Aug. 1, 2002

(54) Adjustable mounting assembly for mounting a support stay of a clamp arm to a dipper arm of a back acter

(76) Inventors: Bartolomew James Cunningham, Navan (IE); James David Barron, Collon (IE); Thomas Martin De Courcey, Collon (IE)

Correspondence Address: John W. Hayes, Lee, Mann, Smith, McWilliams, Sweeney & Ohlson, P.O. Box 2786, Chicago, IL, 60690-2786, US

(21) Appl. No.: 10/066,016

(22) Filed: Jan. 31, 2002

(30) Foreign Application Priority Data
Jan. 31, 2001 (IE) S2001/0079

(51) Int. Cl. B60N 2/48; B60N 2/02

(52) U.S. Cl. 297/377

(57) ABSTRACT

The invention provides an adjustable mounting assembly (5) for mounting a support stay (18) of a clamp arm (7) to a dipper arm (1) of a back actor. The mounting assembly comprises an elongated mounting member (9) defining a longitudinally extending central axis for mounting on the dipper arm with the central axis of the mounting member extending substantially parallel to the dipper arm and an anchor member (17) for anchoring the support stay to the mounting member. The anchor member is selectively engageable with the mounting member in at least two anchor locations spaced apart longitudinally along the central axis of the mounting member. The anchor locations position the clamp arm in an operative orientation with the clamp arm extending outwardly from the dipper arm for co-operating with a bucket mounted at the distal end of the dipper arm or in an inoperative orientation with the clamp arm and the support stay extending substantially parallel to the dipper arm. The assembly allows for the easy adjustment of the clamp arm from an operating to a stowed position.

The present invention relates to an adjustable mounting assembly for mounting a support stay of a clamp arm to a dipper arm of a back acter.

A clamp arm is an arm which is mounted towards the distal end of a dipper arm, adjacent a bucket mounting for co-operating with the bucket for clamping one or more articles between the bucket and the clamp arm. Typically, the clamp arm extends substantially perpendicularly from the dipper arm adjacent the bucket, and by pivoting the bucket towards the clamp arm, an article to be carried can be clamped between the bucket and the clamp arm. Typically, such clamp arms are used in conjunction with the bucket at the end of the dipper arm for carrying relatively long articles, for example, poles stanchions, and the like. Mountings for mounting such clamp arms to a dipper arm are known. Typically, a pivotal anchorage is located adjacent to the distal end of the dipper arm for pivotally connecting the clamp arm to the dipper arm. A support stay for supporting the clamp arm in an orientation extending substantially perpendicularly from the dipper arm extends from the clamp arm intermediate the ends thereof, and is anchored to the dipper arm by a separate anchorage which is spaced apart longitudinally along the dipper arm from the clamp arm anchorage. The anchorage for the support stay may provide a plurality of mounting locations for mounting the support stay for securing the clamp arm, in a plurality of different orientations extending outwardly of the dipper arm at different angles, for in turn, accommodating clamping of different size articles between the clamp arm and a bucket.

However, such known clamp arms, support stays and mounting arrangements suffer from a number of disadvantages. A particularly serious disadvantage is that when the clamp arm is not required, and in particular, when the back acter is to operate the bucket as a digger, it is necessary to either fold away the clamp arm which is time consuming or to remove at least the support stay, and in many cases both the clamp arm and the support stay. Otherwise, the clamp arm and the support stay would impair efficient digging by the bucket. This is a considerable disadvantage, since in general, once removed from a dipper arm a clamp arm and its associated support stay tend to be lost. It is also awkward and time consuming to re-mount a removed assembly or to move the assembly back to the operating position from the folded away position.

There is therefore a need for an adjustable mounting assembly for mounting a support stay of a clamp arm to a dipper arm of a back acter which overcomes this problem.

The present invention is directed towards providing such a mounting assembly.

According to the invention there is provided an adjustable mounting assembly for mounting a support stay of a clamp arm to a dipper arm of a back acter, the mounting assembly comprising an elongated mounting member defining a longitudinally extending central axis for mounting on the dipper arm with the central axis of the mounting member extending substantially parallel to the dipper arm, an anchor member for anchoring the support stay to the mounting member, the anchor member being selectively engageable with the mounting member at at least two anchor locations spaced apart longitudinally along the central axis of the mounting member for respectively supporting the clamp arm in at least one operative orientation with the clamp arm extending outwardly from the dipper arm for co-operating with a bucket mounted at the distal end of the dipper arm for clamping an article therebetween, and an inoperative orientation with the clamp arm and the support stay extending substantially parallel to the dipper arm (the free end of the clamp arm is proximate the dipper arm). Generally the inoperative position of the clamp arm is one in which the clamp arm does not interfere with the working of the bucket. This generally means that the clamp arm does not impede the digging action of the bucket, for example by catching the ground close to the site at which the bucket is digging or by impeding the extent to which the bucket can pivot toward the dipper arm.

In one embodiment of the invention the anchor member is slideable longitudinally along the mounting member between the respective anchor locations. Preferably, a retaining means is provided for retaining the anchor member in slideable engagement with the mounting member.

In another embodiment of the invention a securing means is provided for securing the anchor member at the respective anchor locations.

In one embodiment of the invention the securing means comprises a securing pin which is slideable through the anchor member and engageable with a corresponding receiver in the mounting member. Ideally, the securing pin is slideably carried in a guide bore extending through the anchor member and is slideable between a disengaged position disengaged from the receiver and an engaged position engaging the receiver. Preferably, a follower member extends transversely from the securing pin and is co-operable with a camming surface on the anchor member for operating the securing pin between the engaged and the disengaged positions, and ideally, for releasably retaining the securing pin in the disengaged position.

In one embodiment of the invention the anchor member is selectively engageable with the mounting member at a plurality of spaced apart anchor locations spaced apart longitudinally along the mounting member for supporting the clamp arm at a plurality of respective operative orientations extending outwardly from the dipper at respective different angles to the dipper arm.

A securing catch may be provided for securing the clamp arm in an inoperative orientation or configuration. The securing catch may be provided in addition to the anchoring mechanism described above to help to retain the clamp arm in an inoperative configuration. In this respect it is desirable that the inoperative position at which the clamp arm is held is a position at which the clamp arm is held closest to the dipper arm. In other words it is desirable that in the inoperative position the free end of the clamp arm (the end distal the point of attachment to the mounting member) is proximate the dipper arm.

In such a stowed or inoperative configuration the stay arm will be in a substantially parallel position to the dipper arm. The securing catch aids in prevention of unintentional deployment of the clamp arm.

It will be appreciated that there a number of ways to configure the securing catch mechanism. One desirable way of configuring same is to have a catch mechanism with at least two parts, one part on the mounting assembly (either on the mounting member or the anchor member) and the other on the clamp arm or in the alternative on the support stay.

Desirably the catch mechanism is an automatic one which engages the clamp arm in the inoperative position automatically when the clamp arm is in a desired inoperative position.

In a particular embodiment the catch mechanism comprises a locking member such as a pin and a corresponding engaging member or element such as a receiver. In one arrangement the locking member is slideable through a bore defined in the catch mechanism and is engageable with a corresponding engaging element such as a receiver or a locking member mounted on the support stay. Ideally the locking member is biased towards an engaging position for engaging with the engaging element.

Desirably a retraction mechanism is provided for retracting the locking member from the engaging position to a release position. A cam surface and a cam follower may provide the mechanism for retracting the locking member to the release (disengaged position).

It will be appreciated that the anchoring mechanism described above prevents relative movement of the mounting member and the anchor member by engaging one to another. This in turn can lock against relative motion of the clamp arm to the mounting assembly. However, it is desirable to further secure the clamping arm in the retracted position. The securing mechanism above desirably locks the mounting member and either the stay arm of the clamp arm directly.

In one embodiment of the invention there is provided more than one catch mechanism of the type described above. These may be provided separately as distinct mechanisms or proximate each other to function (in tandem) as a dual locking mechanism. In one embodiment at least two catch mechanisms are provided and arranged to operate in sequence so that one of said catch mechanisms when released allows the clamp arm to move (toward the operating position) and engage in the second catch mechanism. This arrangement is advantageous as it allows for the stage-wise release of the clamp arm from an inoperative position to an operating position (which can then be selected using the adjustable mounting assembly). This arrangement has been found to be very satisfactory as it gives the person releasing the clamp arm a sense of the movement (swing radius) of the clamp arm so that they better anticipate the path the clamp arm will take to its operation position. This in turn helps to avoid injury and indeed damage to the clamp arm were it to fall heavily toward the operating position which might otherwise occur.

When the clamp arm is moved toward the inoperative orientation it is desirable that the catch mechanism automatically engages when the clamp arm is in a desired position. In the dual locking engagement the clamp will first encounter one locking mechanism and then the other. It will be appreciated that where dual catch mechanisms are employed two engaging elements and one locking member could be employed or vice versa. It is not necessary that the each mechanism comprise an engaging element and corresponding locking member.

The double (or dual) catch mechanism can be considered a two stage release mechanism and is particularly desirable that it is arranged to engage the stay arm to the mounting assembly and more particularly to the mounting member of the mounting assembly. In one preferred arrangement the engaging element is a projection on the stay arm with which the engaging member engages.

In a further embodiment of the invention the mounting assembly is mountable on the dipper arm at a location on the dipper arm such that a connecting anchorage for connecting the clamp arm to the dipper arm is located between the mounting assembly and the distal end of the dipper arm, and preferably, when the clamp arm is in the inoperative orientation the clamp arm extends from the connecting anchorage towards the mounting member and advantageously, the support stay extends from the mounting assembly towards the connecting anchorage of the clamp arm.

In another embodiment of the invention a connecting anchorage is provided on the mounting member for pivotally connecting the clamp arm to the dipper arm, the connecting anchorage being provided longitudinally spaced apart from the anchor locations.

In one embodiment of the invention the mounting member defines an elongated track extending parallel to the central axis for slideably carrying the anchor member between the respective anchor locations. The track may comprise one or more grooves in which one or more runners on the anchor member engage and travel or may comprise grips which engage (optionally a top surface of) the anchor member.

In a further embodiment of the invention the mounting assembly comprises the support stay, and in a further embodiment of the invention the clamp arm is provided, the clamp arm being pivotally connected to the connecting anchorage and to the support stay, and the support stay being pivotally connected to the anchor member.

Further the invention provides a dipper arm comprising the mounting assembly according to the invention mounted on the dipper arm.

The invention will be more clearly understood from the following description of an embodiment thereof which is given by way of example only with reference to accompanying drawings, in which;

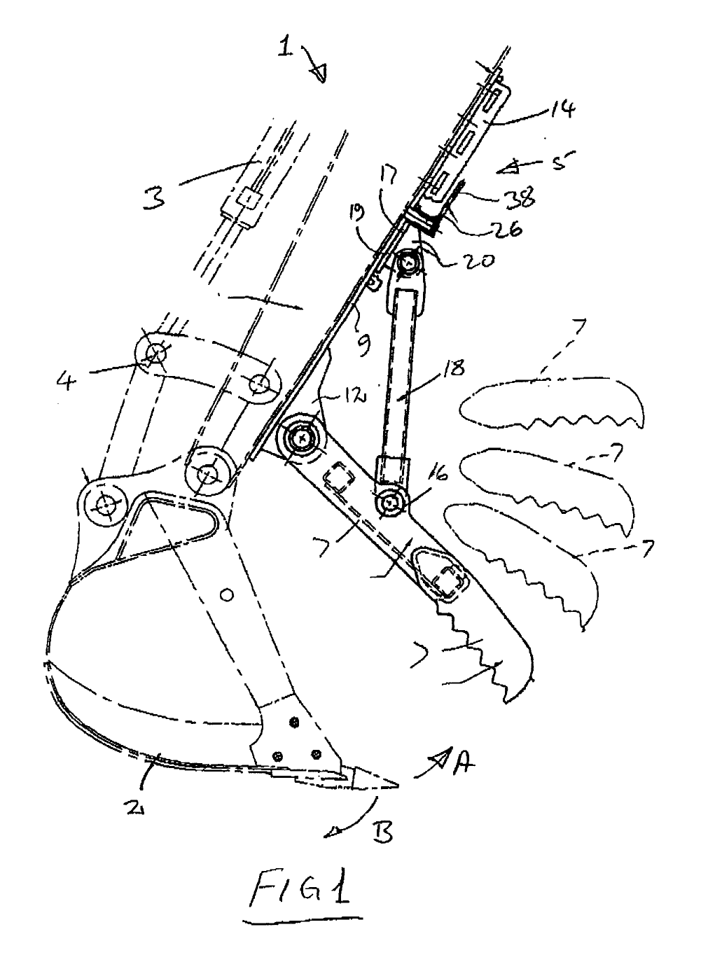

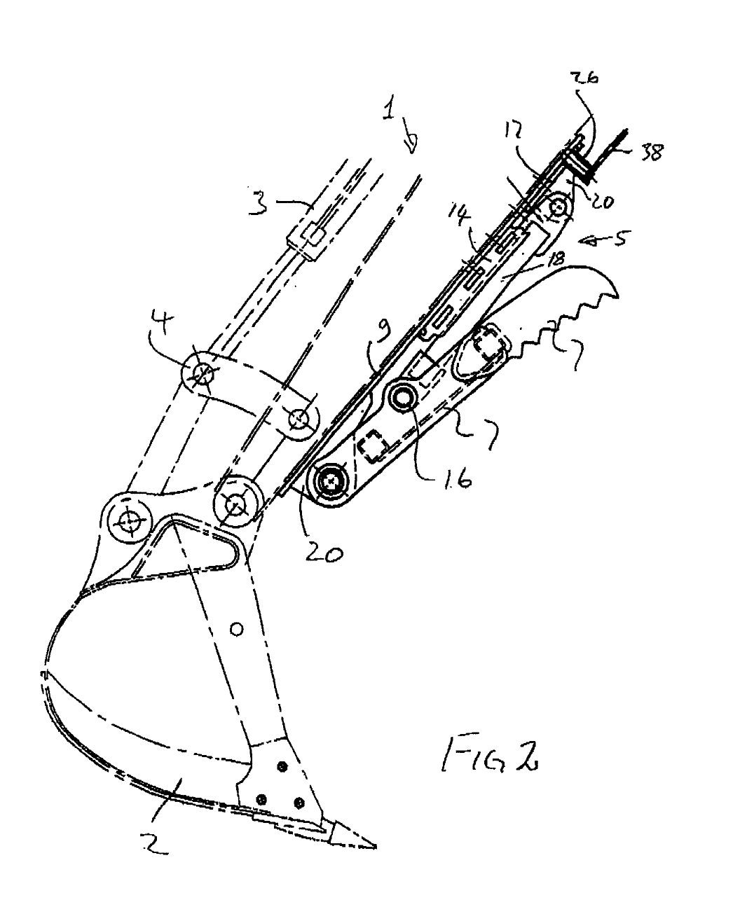

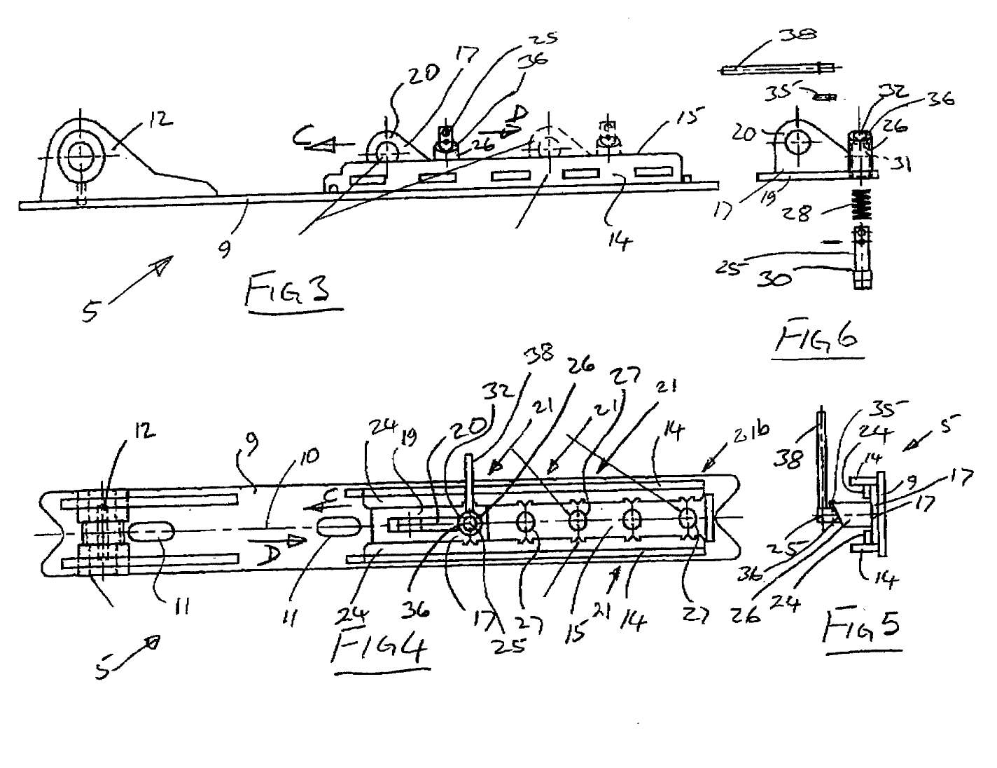

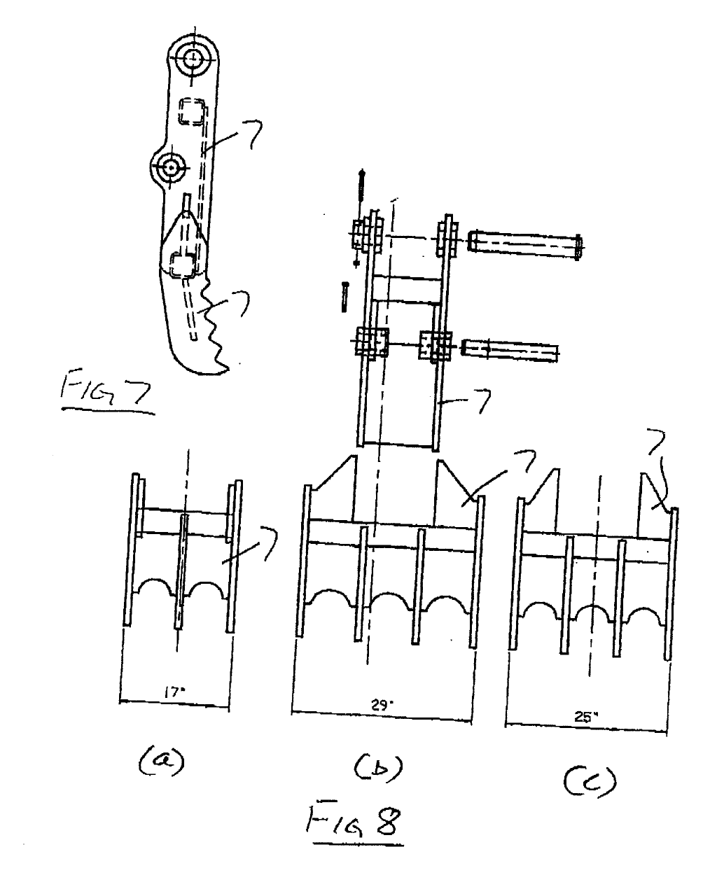

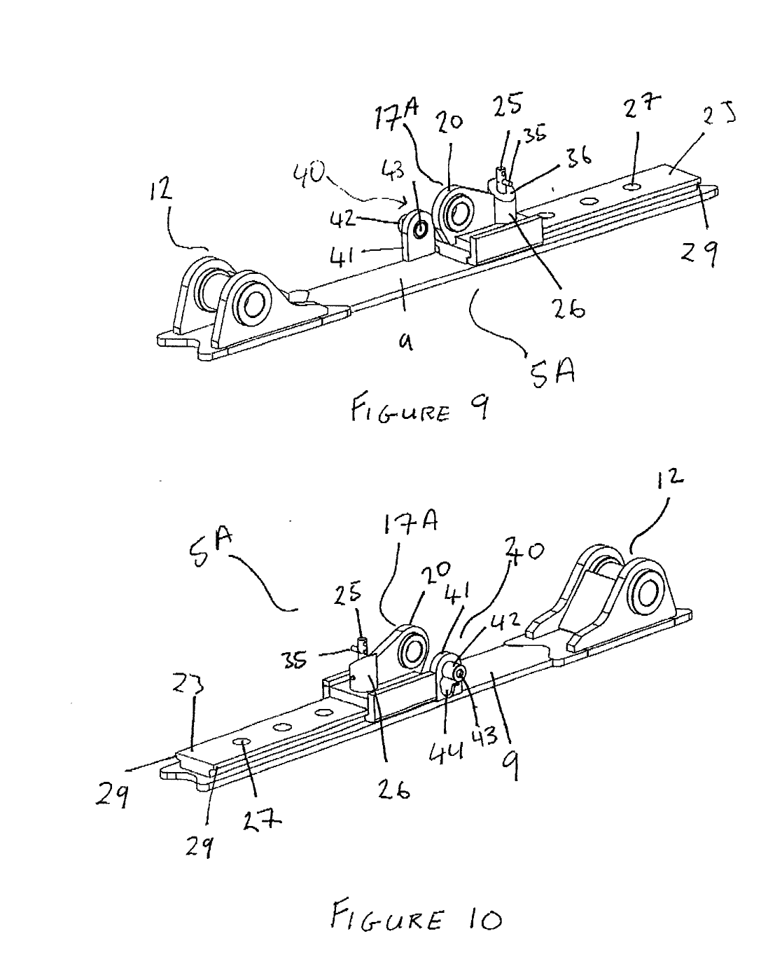

FIG. 1 is a side elevational view of the dipper arm, according to the invention of a back acter having a clamp arm mounted thereto by an adjustable mounting assembly also according to the invention,

FIG. 2 is a view similar to FIG. 1 of the dipper arm illustrating the clamp arm in a different orientation,

FIG. 3 is a side elevational view of the adjustable mounting assembly according to the invention illustrated in FIGS. 1 and 2,

FIG. 4 is a plan view of the adjustable mounting assembly of FIG. 3,

FIG. 5 is an end view of the adjustable mounting assembly of FIG. 3,

FIG. 6 is an exploded side elevational view of a portion of the adjustable mounting assembly of FIG. 3,

FIG. 7 is a side elevational view of the clamp arm, of the dipper arm of FIG. 1,

FIG. 8 (a), (b) and (c) are front elevational views of different sizes of clamp arms for use with the adjustable mounting assembly of FIG. 3,

FIG. 9 is a perspective view of an alternative mounting assembly according to one embodiment of the invention from one side thereof,

FIG. 10 is a perspective view of the mounting assembly of FIG. 9 from the other side thereof,

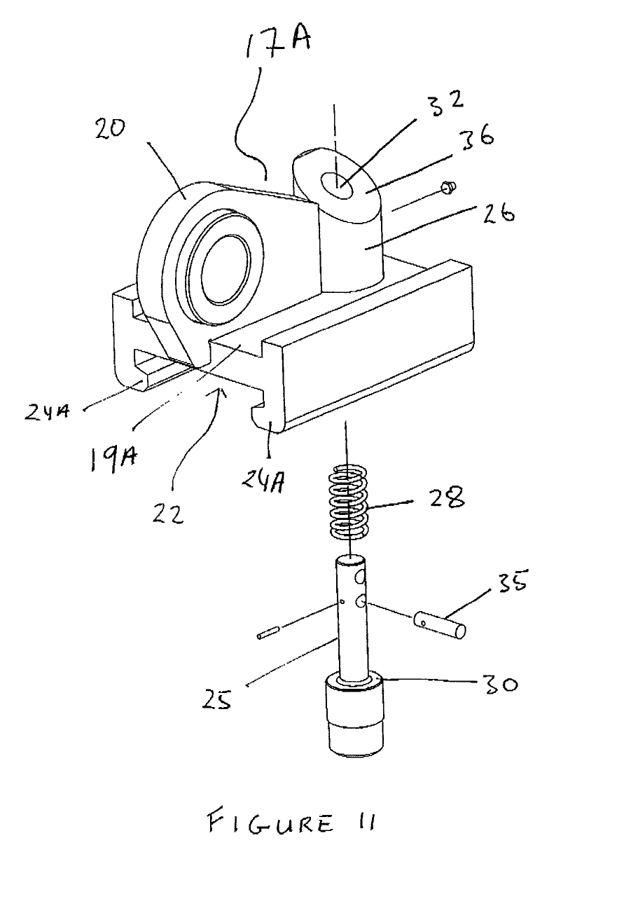

FIG. 11 is an exploded perspective view of an anchor member of the adjustable mounting assembly of FIG. 9,

FIG. 12 is a perspective view of a dipper arm with the mounting assembly of FIG. 9 attached,

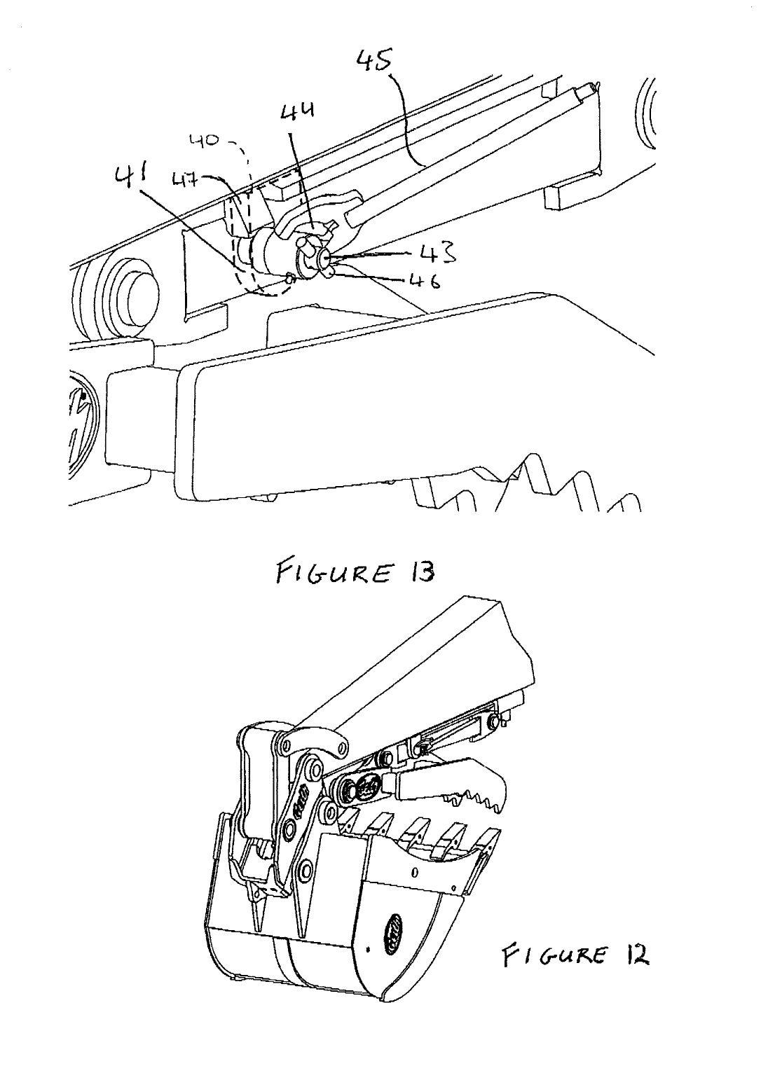

FIG. 13 is an enlarged partial view of FIG. 12,

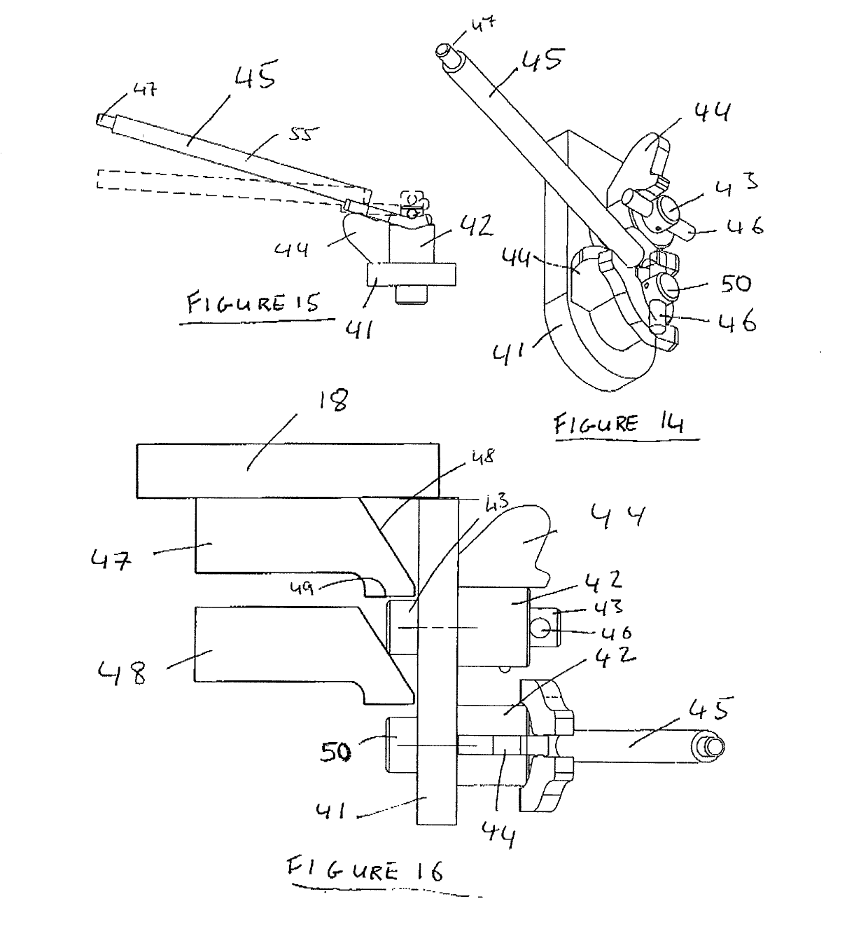

FIG. 14 is a perspective view of part of a dual catch mechanism according to one embodiment of the invention,

FIG. 15 is side elevation of the catch mechanism of FIG. 14, and

FIG. 16 is side elevation of the catch mechanism of FIG. 14 schematically representing the engagement of the locking members and receivers.

Referring to the drawings there is illustrated a dipper arm according to the invention indicated generally by the reference numeral 1 of a back acter (not shown). A digger bucket 2 is pivotally connected to the distal end of the dipper arm 1 and is pivotal in conventional fashion in the direction of the arrows A and B under the action of an hydraulic ram 3 through linkages 4 mounted on the dipper arm 1.

An adjustable mounting assembly according to the invention indicated generally by the reference numeral 5 is secured to the dipper arm 1 for mounting a clamp arm 7 on the dipper arm 1 so that the clamp arm 7 co-operates with the digger bucket 2 for clamping an article therebetween. The mounting assembly 5 comprises an elongated plate member 9 which defines a longitudinally extending central axis 10.

Mounting slots 11 are provided in the plate member 9 for accommodating welds therethrough for securing the mounting assembly 5 to the dipper arm 1. A connecting anchorage 12 mounted on the plate member 9 pivotally connects the clamp arm 7 to the mounting assembly 5. A pair of longitudinally extending spaced apart side members 14 extend upwardly front the plate member 9 and define with the plate member 9 an elongated track 15 which slideably engages an anchor member 17 for anchoring a support stay 18 for in turn supporting the clamp arm 7. The support stay 18 and the clamp arm 7 are pivotally connected at 16.

The anchor member 17 comprises a carrier plate 19 which carries a pivotal anchor bracket 20 for pivotally engaging the support stay 18. The carrier plate 19 is slideable longitudinally in the track 15, and is engageable with the track 15 at a plurality of spaced apart anchor locations 21 for co operating with the support stay 18 for supporting the clamp arm 7 in a plurality of operative orientations extending outwardly of the dipper arm 1, see FIG. 1 and in an inoperative orientation, see FIG. 2 with the clamp arm 7 and the support stay 18 extending substantially parallel to the dipper arm 1.

A retaining means for retaining the carrier plate 19 in the track 15 comprises a pair of longitudinally extending retaining members 24 which extend inwardly from the side members 14 and define with the side members 14 and the plate member 9 the track 15. A securing means for securing the carrier plate 19 and in turn the anchor member 17 in each of the anchor locations 21 comprises a securing pin 25 which is slideably carried in a guide bore 32 extending through tubular guide member 26 and is slideable between a disengaged position illustrated in FIG. 5 to an engaged position with the securing pin 25 engaging a corresponding receiver opening 27 in the selected anchor location 21. A compression spring 28 located in the guide member 26 acts between a shoulder 30 on the securing pin 25 and a shoulder 31 within the bore 32 of the guide member 26 for urging the securing pin 25 into engaged position engaging one of the receiver openings 27 in the selected anchor location 21. A cam follower 35 extending transversely from the securing pin 25 co-operates with a camming surface 36 at the end of the guide member 26 for urging the securing pin 25 between the engaged and disengaged positions as the securing pin 25 is rotated through 180°. A handle 38 extending transversely from the securing pin 25 is provided for rotating the securing pin 25 in the bore 32.

Referring now to FIGS. 9 to 16 there is shown other embodiments of the anchor member 17A. As best seen from FIG. 11 though also in FIGS. 9 and 10 in one alternative embodiment of the invention the mounting member comprises a carrier plate 19A which has a pair of inwardly facing grips 24A together which define a runner with a mouth 22 to receive a track. The anchor member 17A fits to and is slideable longitudinally on a track 23 formed on the mounting member. The track 23 has a pair of grooves 29 which mate with the runner arrangement described above. The track 23 only permits longitudinal movement of the anchor member 17A. In general the remaining features of the device shown are similar to those described above.

It will be noted however that in FIGS. 9 through 16 the mounting assembly 5A further included a catch mechanism 40. The mechanism 40 enables a user to store the clamp arm 7 in a inoperative storage position. In the embodiment of FIGS. 9, 10 and 13 the catch mechanism shown is a single catch mechanism. In FIGS. 14 to 16 the catch mechanism is a dual mechanism.

The mechanism 40 comprises a bracket 41 fixed to the plate 9, a tubular lock pin guide 42 and a lock pin 43 formed to pass through the tubular lock pin guide 42. The lock pin 43 is spring mounted so as to bias the lock pin 43 toward an engaging position in a manner which will be described in more detail below.

The mechanism will now be described in detail with reference to FIGS. 14 through 16 though the mechanism of FIGS. 9, 10 and 13 works analogously.

A retaining pin 46 is inserted through a bore in the top of the lock pin 43 in a dowel arrangement. One of the main functions of the retaining pin 46 is to act as a grip on which a tool 45 can act as will be described below.

Also provided is a pin lock lever tool 45 having a handle with a forked (or bifurcated) head 46 which engages underneath the retaining pin 46. The tool 45, in particular a notch 60 formed in the forked head thereon also engages with a butterfly wing protrusion or grip 44 on the tubular lock pin guide 42. The tool 45 can then be used to exert pressure upward on the pin 46 thus retracting the pin 43 toward a release position as illustrated in FIG. 15 where the effect of a downward force applied to the tool is shown in dashed outline. A further possible use of the tool 45 is to engage with the pin 25 of the anchor adjustment mechanism. The end 47 thereof on the handle could be provided with a notch or groove that will engage with the pin and allow it to be turned.

Once the catch mechanism has been released then the adjustable anchor mechanism can be used to hold the clamp arm in the desired position as described above.

As best seen from FIGS. 13 (single latch mechanism) and 16 (a dual latch mechanism) a member 47 is attached to the support stay 18. When the anchor member is moved toward the inoperative position in which it is to be retained the members 47 is pressed against the dual lock pins 43. The pins 43 being spring loaded allow the bevelled surface 48 of the member 47 to push past by at least partially retracting and then engages again with the member 47 by moving outward and locking behind the member 47 and in particular a flat abutment surface 49 thereon.

A similar action takes place with the second member 48 and the second pin 50 thus forming a dual locking mechanism as best seen from FIG. 16 where the double lock position is shown.

Releasing the stay arm 18 (and thus also the clamp arm) is achieved using the tool 45 as was described above—first retracting pin 43 and the pin 50.

It may be desirable that the catch mechanism be locked against accidental release. This may be achieved by locking the movement of the pin 43 and or the pin 50. For example the tubular pin lock guide or barrel 42 can also be arranged to lock the pin 43 and/or 50 in the extended position. One method of achieving this is to have rotation of the barrel 42 lock movement of the pin. Reversing the rotational movement will release the pin.

In use, with the mounting assembly 5 secured to the dipper arm 1, the clamp arm 7 is ready for use. When it is desired to use the clamp arm 7 for clamping an article between itself and the digger bucket 2 the anchor member 17 is urged along the track 15 in the direction of the arrow C until the clamp arm 7 extends from the dipper arm 1 in a desired outwardly extending operative orientation. When the clamp arm 7 is at the desired operative orientation the securing pin 25 is urged from the disengaged to the engaged position by rotating the securing pin 25 through 180° for engaging the receiver opening 27 in the selected anchor location 21. With the securing pin 25 secured In the corresponding receiver opening 27 the clamp arm 7 is ready for use.

When the clamp arm 7 is not required the securing pin 25 is disengaged from the receiver opening 27 by rotating the securing pin 25 through 180°, so that the cam follower 35 co-operating with the camming surface 36 urges the securing pin 25 from the engaged to the disengaged position. The anchor member 17 is then urged along the track 15 in the direction of the arrow D until the anchor member 17 is in the last anchor location 21b. The securing pin 25 is rotated through 180° for engaging the corresponding receiver opening 27. With the anchor member 17 secured in the last anchor location 21b the clamp arm 7 is in the inoperative orientation extending substantially parallel to the dipper arm in a direction from the connecting anchorage 12 towards the anchor member 17.

Additionally, the support stay 18 also lies substantially parallel to the dipper arm 1 and extends from the anchor member 17 towards the connecting anchorage 12. Thus, in the inoperative position the clamp arm, 7 and the support stay 18 do not impair normal digging by the digger bucket 2, and there is therefore no need to remove the clamp arm 7 nor is there a need to remove the support stay 18. Accordingly the mounting assembly according to the invention overcomes the problems of prior art mountings for carrier arms.

Referring now in particular to FIGS. 8 (a), (b) and (c) clamp arms 7 of different sizes which may be used in conjunction with the mounting assembly 5 are illustrated. A clamp arm of a size corresponding to the size of the digger bucket would normally be selected for use.

The invention is not limited to the embodiment hereinbefore described which may be varied in construction and detail.

It will be appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

The words “comprises/comprising” and the words “having/including” when used herein with reference to the present invention are used to specify the presence of stated features, integers, steps or components but does not preclude the presence or addition of one or more other features, integers, steps, components or groups thereof.

1. An adjustable mounting assembly for mounting a support stay of a clamp arm to a dipper arm of a back acter, the mounting assembly comprising:
an elongated mounting member defining a longitudinally extending central axis for mounting on the dipper arm with the central axis of the mounting member extending substantially parallel to the dipper arm, and
an anchor member for anchoring the support stay to the mounting member, the anchor member being selectively engageable with the mounting member at at least two anchor locations spaced apart longitudinally along the central axis of the mounting member for respectively supporting the clamp arm in at least one operative orientation with the clamp arm extending outwardly from the dipper arm for co-operating with a bucket mounted at the distal end of the dipper arm for clamping an article therebetween, and an inoperative orientation with the clamp arm and the support stay extending substantially parallel to the dipper arm.

2. An adjustable mounting assembly as claimed in claim 1 wherein the anchor member is slideable longitudinally along the mounting member between the respective anchor locations.

3. An adjustable mounting assembly as claimed in claim 1, wherein a retaining means is provided for retaining the anchor member in slideable engagement with the mounting member.

4. An adjustable mounting assembly as claimed in claim 1, wherein a securing means is provided for securing the anchor member at the respective anchor locations.

5. An adjustable mounting assembly according to claim 4 wherein the securing means comprises a securing pin which is slideable through the anchor member and engageable with a corresponding receiver in the mounting member.

6. An adjustable mounting assembly according to claim 5 wherein a guide bore, through which the securing pin is slideably carried, extends through the anchor member and is slideable between a disengaged position disengaged from the receiver and an engaged position for engaging the receiver.

7. An adjustable mounting assembly according to claim 6 wherein a follower member extends transversely from the securing pin and is co-operable with a camming surface on the anchor member for operating the securing pin between the engaged and the disengaged positions.

8. An adjustable mounting assembly according to claim 5 wherein the securing pin releasably retains the securing pin in the disengaged position.

9. An adjustable mounting assembly according to claim 1 wherein the anchor member is selectively engageable with the mounting member at a plurality of spaced apart anchor locations spaced apart longitudinally along the mounting member for supporting the clamp arm at a plurality of respective operative orientations extending outwardly from the dipper at respective different angles to the dipper arm.

10. An adjustable mounting assembly according to claim 1 wherein the assembly further comprises a securing catch for securing the clamp arm in an inoperative orientation.

11. An adjustable mounting assembly according to claim 10 wherein the securing catch mechanism comprises at least two parts one part on the mounting assembly the other on the clamp arm or the support stay.

12. An adjustable mounting assembly according to claim 10 wherein the securing catch mechanism comprises at least two catch mechanisms.

13. An adjustable mounting assembly according to claim 10 wherein the securing catch mechanism automatically engages when the clamp arm is in a desired inoperative position.

14. An adjustable mounting assembly as claimed in claim 10 wherein said securing catch comprises two or more catch mechanisms each individually restricting movement of the clamp arm from an inoperative position.

15. An adjustable mounting assembly as claimed in any of the preceding claims wherein the adjustable mounting assembly is mountable on the dipper arm at a location on the dipper arm such that a connecting anchorage for connecting the clamp arm to the dipper arm is located between the mounting assembly and the distal end of the dipper arm.

16. An adjustable mounting assembly as claimed in claim 15 wherein when the clamp arm is in the inoperative orientation the clamp arm extends from the connecting anchorage towards the mounting member.

17. An adjustable mounting assembly as claimed in claim 16 wherein in the inoperative position the support stay extends from the mounting assembly towards the connecting anchorage of the clamp arm.

18. An adjustable mounting assembly as claimed in claim 1 wherein a connecting anchorage is provided on the mounting member for pivotally connecting the clamp arm to the dipper arm, the connecting anchorage being provided longitudinally spaced apart from the anchor locations.

19. An adjustable mounting assembly as claimed in claim 1 wherein the mounting member defines an elongated track extending parallel to the central axis for slideably carrying the anchor member between the respective anchor locations.

20. An adjustable mounting assembly as claimed in claim 1 wherein the mounting assembly further comprises at least one of the group consisting of a support stay and a clamp arm.

21. An adjustable mounting assembly as claimed in claim 20 comprising both a support stay and a clamp arm, the clamp arm for pivotal connection to the connecting anchorage and to the support stay, and the support stay for pivotal connection to the anchor member.

22. A dipper arm comprising the mounting assembly of claim 1 mounted on the dipper arm.

23. A hydraulically operated machine having the dipper arm of claim 22.
